(19) United States
(12) Patent Application Publication
(10) Pub. No.: US 2008/0032053 A1
(43) Pub. Date: Feb. 7, 2008

(54) Low refractive index composition

(76) Inventors: Kostantinos Kourtakis, Media, PA (US); Mark R. McKeever, Wilmington, DE (US); Paul Gregory Bekiarian, Wilmington, DE (US); Shekhar Subramoney, Hockessin, DE (US); Maria Petrucci-Samija, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/888,383

(22) Filed: Aug. 1, 2007

Related U.S. Application Data
(60) Provisional application No. 60/835,826, filed on Aug. 4, 2006.

(51) Int. Cl. C09J 11/06; B05D 5/06

(52) U.S. Cl. 427/387; 106/287.14

(57) ABSTRACT

A low refractive index composition is provided comprising the reaction product of: (i) a cross-linkable polymer; (ii) a multiolefinic crosslinker; and (iii) a plurality of solid nanosilica particles; (iv) a plurality of porous nanosilica particles; (v) an oxysilane having at least one polymerizable functional group and at least one of a hydrolysis and condensation product of said oxysilane; and (vi) a free radical polymerization initiator; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles. Further provided is a liquid mixture for forming a low refractive index coating, an article comprising a substrate having an anti-reflective coating, and a method for forming an anti-reflective coating on a substrate.

### BACKGROUND OF THE INVENTION

1. Field of the Invention

The present invention relates to the field of low refractive index compositions having utility as anti-reflective coatings for optical display substrates. The compositions are the reaction product of cross-linkable polymer, multiolefinic crosslinker, solid nanosilica particles, porous nanosilica particles, oxysilane having at least one polymerizable functional group, and free radical polymerization initiator.

2. Description of Related Art

Antireflective coatings containing low refractive index materials are typically located on the outermost surface of optical displays, such as cathode ray tube displays (CRTs), plasma display panels (PDPs), electroluminescence displays (ELDs), and liquid crystal displays (LCDs), to prevent contrast reduction or reduction of visibility due to reflection of ambient light by making use of optical interference. As such, antireflective coatings desirably have high abrasion resistance and adhesion to the underlying layer.

Refractive index of a material can be reduced by inclusion of fluorine and by decreasing the material density (e.g., voids), but both approaches are accompanied by reductions in film strength (i.e., abrasion resistance) as well as adhesion. It is an ongoing industry challenge to satisfy both the requirements for low refractive index and high abrasion resistance.

It is known that low refractive index anti-reflective coatings can be prepared from fluorinated polymers. The refractive index of a fluorinated polymer correlates with the amount of fluorine in the polymer. Increasing the fluorine content in the polymer decreases the refractive index of the polymer. Considerable industry attention has been directed towards the use of fluorinated polymers in anti-reflective coatings.

Fluoropolymers with low crystallinity that are soluble in organic solvents typically form coatings having undesirable mechanical properties, such as poor abrasion resistance and poor interfacial adhesion between the fluoropolymer coating and the underlying optical display substrates such as plastics and glass. Various modifications have been made in order to improve their abrasion resistance and adhesion to substrates.

Compounding inorganic oxide nanoparticles into antireflection coatings has been shown to improve abrasion resistance and strength after cure as well as adhesion to substrates.

When mixing a fluoropolymer and inorganic oxide nanoparticles, it is necessary to prevent undesired agglomeration of the nanoparticles. One of the known methods is to surface treat inorganic oxide nanoparticies with an alkoxysilane.

Many abrasion-improving compositions are derived from aqueous sols of inorganic oxide nanoparticles by a process in which a free-radically curable binder precursor and other optional ingredients are blended into an aqueous sol. The resultant composition may then be dried to remove substantially all of the water. An organic solvent may then be added, if desired, in amounts effective to provide the inorganic oxide composition with viscosity characteristics suitable for coating onto a desired substrate. After coating, the inorganic oxide composition can be dried to remove substantially all of the solvent and then exposed to a suitable source of energy to cure the free-radically curable binder precursor, thereby providing the desired, abrasion resistant layer on the substrate.

Unfortunately, however, the incorporation of fluoropolymer into such an inorganic oxide composition is extremely difficult. Because fluoropolymers are both hydrophobic (incompatible with water) and oleophobic (incompatible with nonaqueous organic substances), the incorporation of fluoropolymer into such an inorganic oxide composition, which is hydrophilic, often results in phase separation between the fluoropolymer and other ingredients of the inorganic oxide composition. Inorganic oxide colloid flocculation may also result. This undesirable phase separation and/or inorganic oxide colloid flocculation can result not only when the ingredients are mixed together, but also during the stripping process, i.e., when water is removed from the blended composition. Finally, not only can fluoropolymer be incompatible with the colloidal inorganic oxide component, but such materials also would be expected to adversely affect the hardness and abrasion resistance characteristics of a resultant cured composite into which such fluoropolymers are incorporated.

For instance, WIPO International Publication Number WO 2006/0033456 discloses combining a binder, fine particles and at least one of a hydrosylate and a partial condensate of certain organosilanes. The technique is effective to some extent in improving scratch resistance but is still insufficient for improving scratch resistance of a coating film that essentially lacks film strength and interfacial adhesion.

Thus there exists an industry need for anti-reflective coatings that exhibit low visible light reflectivity, adhesion to optical display substrates and abrasion resistance.

### SUMMARY OF THE INVENTION

The compositions disclosed herein meet these needs by providing low refractive index compositions of utility for forming anti-reflective coatings having low visible light reflectivity and excellent abrasion resistance and adhesion to optical display substrates.

Briefly stated, and in accordance with one embodiment of the present invention, there is provided low refractive index compositions comprising the reaction product of: (i) a cross-linkable polymer; (ii) a multiolefinic crosslinker; and (iii) a plurality of solid nanosilica particles; (iv) a plurality of porous nanosilica particles; (v) an oxysilane having at least one polymerizable functional group and at least one of a hydrolysis and condensation product of said oxysilane; and (vi) a free radical polymerization initiator; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles.

Pursuant to another aspect of the present invention, there is provided a liquid mixture for forming a low refractive index coating, said liquid mixture comprising: a solvent having dissolved therein: (i) a cross-linkable polymer; (ii) a multiolefinic crosslinker; (iii) an oxysilane having at least one polymerizable functional group, and at least one of a hydrolysis and condensation product of said oxysilane; and (iv) a free radical polymerization initiator; and wherein the solvent has suspended therein: (v) a plurality of solid nanosilica particles; (vi) a plurality of porous nanosilica particles; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles.

Pursuant to another aspect of the present invention, there is provided an article comprising a substrate having an anti-reflective coating, wherein said coating comprises the reaction product of: (i) a cross-linkable polymer; (ii) a multiolefinic crosslinker; (iii) a plurality of solid nanosilica particles; (iv) a plurality of porous nanosilica particles; (v) an oxysilane having at least one polymerizable functional group and at least one of a hydrolysis and condensation product of said oxysilane; and (vi) a free radical polymerization initiator; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles.

Pursuant to another aspect of the present invention, there is provided a method for forming an anti-reflective coating on a substrate comprising: (i) preparing a liquid mixture comprising a solvent having dissolved therein: (1) a cross-linkable polymer; (2) a multiolefinic crosslinker; (3) an oxysilane having at least one polymerizable functional group, and at least one of a hydrolysis and condensation product of said oxysilane; (4) a free radical polymerization initiator; and wherein the solvent has suspended therein: (5) a plurality of solid nanosilica particles; (6) a plurality of porous nanosilica particles; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles; (ii) applying a coating of said liquid mixture on a substrate to form a liquid mixture coating on said substrate; (iii) removing solvent from said liquid mixture coating to form an uncured coating on said substrate; and (iv) curing said uncured coating thereby forming a stratified anti-reflective coating on said substrate.

### FIGURES

The invention will be more fully understood from the following detailed description, taken in connection with the accompanying drawing in which:

FIG. 1 is a transmission electron micrograph of a cross-section of a film having an anti-reflective coating disclosed herein.

While the present invention will be described in connection with a preferred embodiment thereof, it will be understood that it is not intended to cover all alternatives, modifications, and equivalents as may be included within the spirit and scope of the invention as defined by the appended claims.

### DETAILED DESCRIPTION

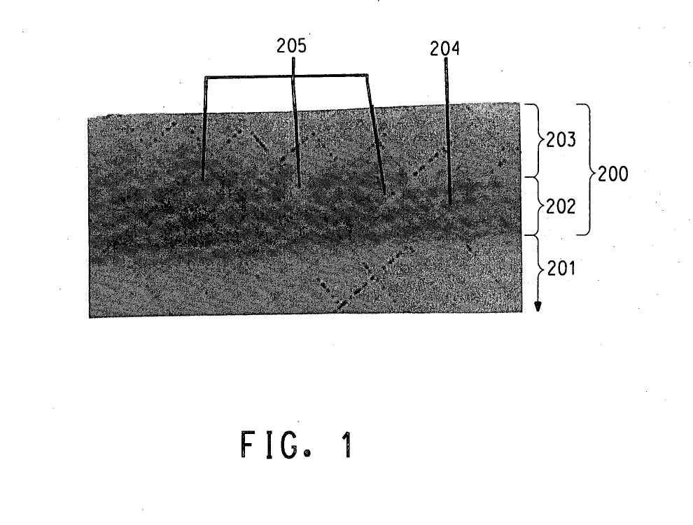

FIG. 1 is a transmission electron micrograph (TEM) of a cross-section of the stratified anti-reflective coating 200 of present Example 5, wherein the coating is the reaction product of: (i) a fluoroelastomer having cure sites; (ii) multiolefinic crosslinker; (iii) a plurality of solid nanosilica particles, (iv) a plurality of hollow nanosilica particles; (v) an oxysilane having acryloyloxy functional groups; and (vi) a free radical polymerization initiator. The stratified anti-reflective coating 200 is on acrylate hard-coated, triacetyl cellulose (TAC) film, 201 corresponding to a portion of the thickness of the acrylic hardcoat. To form the stratified anti-reflective coating composition 200, a liquid uncured composition comprising Viton® GF200S (fluoroelastomer containing cure sites), Sartomer SR533 (triallylisocyanurate (crosslinker)), Ciba® Irgacure® 651 (2,2-dimethoxy-1,2-diphenylethane-1-one (photoinitiator)), Rahn Genocure® MBF (methylbenzoylformate (photoinitiator)), Ciba® Darocur® ITX (mixture of 2-isopropylthioxanthone and 4-isopropylthioxanthone (photoinitiator)), nanosilica composite of Nissan MEK-ST solid nanosilica particles (median particle diameter d₅₀ of about 16 nm), SKK hollow nanosilica particles (median particle diameter d₅₀ of about 41 nm) and acryloxypropyltrimethoxysilane (oxysilane), and propyl acetate (solvent) is micro-gravure coated on to substrate 201. The solvent is removed by evaporation, and the composition is cured by exposure to UV radiation at 85° C. for 5 minutes. The resultant coated TAC film is ultramicrotomed at room temperature to produce cross sections 80 to 100 nm thick. The cross sections are floated onto a boat of de-ionized water adjacent to the diamond knife of the ultramicrotome and picked up from the water onto holey-carbon coated TEM grids (200 mesh Cu grids). The thin sections are imaged in a Philips CM-20 Ultratwin TEM equipped with a Link light-element energy dispersive spectroscopy (EDS) analyzer. The TEM is operated at an accelerating voltage of 200 kV and bright-field images of the cross-sectional regions of interest are obtained in the high-resolution (HR) mode and recorded on SO-163 sheet films. The FIG. 1 image was obtained at a magnification of 100 kX. Elemental analysis (EDX (energy dispersive X-ray microanalysis)) of regions of interest in the sample are performed by operating the TEM in the selected area (SA) mode and using an electron probe smaller than 50 nm in diameter. Such a small probe allows for effective discrimination of the elemental composition of the individual strata of the anti-reflection coating 200. The resultant anti-reflection coating 200 is about 100 nm thick and comprises a first stratum 202 located substantially adjacent to the acrylate hardcoated substrate 201, and a second stratum 203 located on the first stratum. TEM and EDX reveals that the first stratum 202 contains the reaction product of fluoroelastomer, crosslinker and nanosilica composite of solid and hollow nanosilica and oxysilane, and the second stratum 203 contains the reaction product of fluoroelastomer and crosslinker, with solid and hollow nanosilica substantially absent from the second stratum 203. Solid nanosilica particles 204 and hollow nanosilica particles 205 are evident throughout the first stratum 202.

One component of the uncured composition is cross-linkable polymer. The term “cross-linkable polymer” refers to any polymer capable of being cross-linked. Examples of such cross-linkable polymers include acrylics, aminoplasts, urethanes, carbamates, carbonates, polyesters, epoxies, silicones, polyamides, and cure-site polymers. These polymers can also contain functional groups characteristic of more than one class, as for example, polyester amides, urethane acrylates and carbamate acrylates. These polymers also include partially or fully fluorinated fluoropolymers. The cross-linkable polymers have a refractive index of from about 1.20 to about 1.46, preferably from about 1.30 to about 1.46, and have solubility in polar aprotic organic solvents.

Fluoropolymer of utility in forming the low refractive index layer composition is described here in more detail. Fluoropolymers are obtained from fluorine-containing vinyl monomers including fluoroolefins (e.g., fluoroethylene, vinylidene fluoride, tetrafluoroethylene, and hexafluoropropylene), partially or completely fluorinated alkyl ester derivatives of (meth)acrylic acid, and partially or completely fluorinated vinyl ethers. Hexafluoropropylene is a particularly preferred monomer from the standpoint of availability as well as the refractive index, solubility and transparency of the resultant fluoropolymers. As the copolymerization ratio of the fluorine-containing vinyl monomer increases, the refractive index becomes smaller, but the polymer film strength can decrease. From this viewpoint, the fluorine-containing vinyl monomer is generally used to give a fluorine content of about 20% to about 70% by weight, preferably 30% to 50% by weight, in the resulting cross-linkable polymer.

Fluoropolymer can contain a repeating unit having a (meth)acryloyl group in the side chain thereof. As the ratio of the (meth)acryloyl group-containing repeating unit increases, the film strength increases, but the refractive index also increases. An amount of the (meth)acryloyl group-containing repeating unit of utility in the cross-linkable polymer is generally from about 5% to about 90% by weight, while varying depending on the fluorine-containing vinyl monomer combined therewith.

In addition to the fluorine-containing vinyl monomer unit and the (meth)acryloyl group-containing unit, the cross-linkable polymer can contain one or more kinds of repeating units derived from other vinyl monomers for improving adhesion to a substrate, adjusting the glass transition temperature (T_{g}) that contributes to the film strength, and improving the solubility in a solvent, transparency, slip properties, antidust and antifouling properties, and the like. The ratio of the other vinyl monomer units in the copolymer is generally from 0 to about 65 mol %.

Examples of useful other vinyl monomers include olefins (e.g., ethylene, propylene, isoprene, vinyl chloride, and vinylidene chloride), acrylic esters (e.g., methyl acrylate, ethyl acrylate, 2-ethylhexyl acrylate, and 2-hydroxyethyl acrylate), methacrylic esters (e.g., methyl methacrylate, ethyl methacrylate, butyl methacrylate, and 2-hydroxyethyl methacrylate), styrene derivatives (e.g., styrene, p-hydroxymethylstyrene, and p-methoxystyrene), vinyl ethers (e.g., methyl vinyl ether, ethyl vinyl ether, cyclohexyl vinyl ether, hydroxyethyl vinyl ether, and hydroxybutyl vinyl ether), vinyl esters (e.g., vinyl acetate, vinyl propionate, and vinyl cinnamate), unsaturated carboxylic acids (eg., acrylic acid, methacrylic acid, crotonic acid, maleic acid, and itaconic acid), acrylamides (e.g., N,N-di methyl acrylamide, N-t-butylacrylamide, and N-cyclohexylacryl amide), methacrylamides (e.g., N,N-dimethylmethacrylamide), and acrylonitrile.

In one embodiment, the cross-linkable polymer is fluoroelastomer having at least one cure site. Example cure sites of utility include bromine, iodine and ethenyl. Fluoroelastomer contains at least about 65 weight % fluorine, preferably at least about 70 weight % fluorine, and is a substantially amorphous copolymer characterized by having carbon-carbon bonds in the copolymer backbone. Fluoroelastomer comprises repeating units arising from two or more types of monomers and has cure sites allowing for crosslinking to form a three dimensional network. A first monomer type gives rise to straight fluoroelastomer chain segments with a tendency to crystallize. A second monomer type having a bulky group is incorporated into the fluoroelastomer chain at intervals to break up such crystallization tendency and produce a substantially amorphous elastomer. Monomers of utility for straight chain segments are those without bulky substituents and include: vinylidene fluoride (VDF), CH₂═CF₂; tetrafluoroethylene (TFE), CF₂═CF₂; chlorotrifluoroethylene (CTFE), CF₂═CFCl; and ethylene (E), CH₂═CH₂. Monomers with bulky groups useful for disrupting crystallinity include hexafluoropropylene (HFP), CF₂═CFCF₃; 1-hydropentafluoropropylene, CHF═CFCF₃; 2-hydropentafluoropropylene, CF₂═CHCF₃; perfluoro(alkyl vinyl ether)s (e.g., perfluoro(methyl vinyl)ether (PMVE), CF₂═CFOCF₃); and propylene (P), CH₂═CHCH₃. Fluoroelastomers are generally described by A. Moore in Fluoroelastomers Handbook: The Definitive User's Guide and Databook, William Andrew Publishing, ISBN 0-8155-1517-0 (2006).

In one embodiment, fluoroelastomers have at least one cure site selected from the group consisting of bromine, iodine (halogen) and ethenyl. The cure sites can be located on, or on groups attached to, the fluoroelastomer backbone and in this instance arise from including cure site monomers in the polymerization to make the fluoroelastomer. Halogenated cure sites can also be located at fluoroelastomer chain ends and in this instance arise from the use of halogenated chain transfer agents in the polymerization to make the fluoroelastomer. The fluoroelastomer containing cure sites is subjected to reactive conditions, also referred to as curing (e.g., thermal or photochemical curing), that results in the formation of covalent bonds (i.e., crosslinks) between the fluoroelastomer and other components in the uncured composition. Cure site monomers leading to the formation of cure sites located on, or on groups attached to, the fluoroelastomer backbone generally include brominated alkenes and brominated unsaturated ethers (resulting in a bromine cure site), iodinated alkenes and iodinated unsaturated ethers (resulting in an iodine cure site), and dienes containing at least one ethenyl functional group that it is not in conjugation with other carbon-carbon unsaturation or carbon-oxygen unsaturation (resulting in an ethenyl cure site). Additionally, or alternatively, iodine atoms, bromine atoms or mixtures thereof can be present at the fluoroelastomer chain ends as a result of the use of chain transfer agent during polymerization to make the fluoroelastomer. Fluoroelastomers of utility generally contain from about 0.25 weight % to about 1 weight % of cure site, preferably about 0.35 weight % of cure site, based on the weight of monomers comprising the fluoroelastomer.

Fluoroelastomer containing bromine cure sites can be obtained by copolymerizing brominated cure site monomers into the fluoroelastomer during polymerization to form the fluoroelastomer. Brominated cure site monomers have carbon-carbon unsaturation with bromine attached to the double bond or elsewhere in the molecule and can contain other elements including H, F and O. Example brominated cure site monomers include bromotrifluoroethylene, vinyl bromide, 1-bromo-2,2-difluoroethylene, perfluoroallyl bromide, 4-bromo-1,1,2-trifluorobutene, 4-bromo-3,3,4,4-tetrafluoro-1-butene, 4-bromo-1,1,3,3,4,4,-hexafluorobutene, 4-bromo-3-chloro-1,1,3,4,4-pentafluorobutene, 6-bromo-5,5,6,6-tetrafluorohexene, 4-bromoperfluoro-1-butene, and 3,3-difluoroallyl bromide. Further examples include brominated unsaturated ethers such as 2-bromo-perfluoroethyl perfluorovinyl ether and fluorinated compounds of the class BrCF₂(perfluoroalkylene)OCF═CF₂, such as CF₂BrCF₂OCF═CF₂, and fluorovinyl ethers of the class ROCF═CFBr and ROCBr=CF₂, where R is a lower alkyl group or fluoroalkyl group, such as CH₃OCF═CFBr and CF₃CH₂OCF═CFBr.

Fluoroelastomer containing iodine cure sites can be obtained by copolymerizing iodinated cure site monomers into the fluoroelastomer during polymerization to form the fluoroelastomer. Iodinated cure site monomers have carbon-carbon unsaturation with iodine attached to the double bond or elsewhere in the molecule and can contain other elements including H, Br, F and O. Example iodinated cure site monomers include iodoethylene, iodotrifluoroethylene, 4-iodo-3,3,4,4-tetrafluoro-1-butene, 3-chloro-4-iodo-3,4,4-trifluorobutene, 2-iodo-1,1,2,2-tetrafluoro-1-(vinyloxy)ethane, 2-iodo-1-(perfluorovinyloxy)-1,1,2,2-tetrafluoroethylene, 1, 1,2,3,3,3-hexafluoro-2-iodo-1-(perfluorovinyloxy)propane, 2-iodoethyl vinyl ether, and 3,3,4,5,5,5-hexafluoro-4-iodopentene. Further examples include olefins of the formula CHR═CHZCH₂CHRI, wherein each R is independently H or CH₃, and Z is a C₁-C₁₈ (per)fluoroalkylene radical, linear or branched, optionally containing one or more ether oxygen atoms, or a (per)fluoropolyoxyalkylene radical. Further examples of iodinated cure site monomers of utility are unsaturated ethers of the formula I(CH₂CF₂CF₂)ₙOCF═CF₂ and ICH₂CF₂O[CF(CF₃)CF₂O]ₙCF═CF₂, wherein n=1-3.

Fluoroelastomer containing ethenyl cure sites is obtained by copolymerizing ethenyl containing cure site monomers into the fluoroelastomer during polymerization to form the fluoroelastomer. Ethenyl cure site monomers have carbon-carbon unsaturation with ethenyl functionality that it is not in conjugation with other carbon-carbon or carbon-oxygen unsaturation. Thus, ethenyl cure sites can arise from non-conjugated dienes having at least two points of carbon-carbon unsaturation and optionally containing other elements including H, Br, F and O. One point of carbon-carbon unsaturation is incorporated (i.e., polymerizes) into the fluoroelastomer backbone, the other is pendant to the fluoroelastomer backbone and is available for reactive curing (i.e., crosslinking). Example ethenyl cure site monomers include non-conjugated dienes and trienes such as 1,4-pentadiene, 1,5-hexadiene, 1,7-octadiene, 8-methyl-4-ethylidene-1,7-octadiene and the like.

Preferred amongst the cure site monomers are bromotrifluoroethylene, 4-bromo-3,3,4,4-tetrafluoro-1-butene and 4-iodo-3,3,4,4-tetrafluoro-1-butene-1.

In on embodiment, halogen cure sites can be present at fluoroelastomer chain ends as the result of the use of bromine and/or iodine (halogenated) chain transfer agents during polymerization of the fluoroelastomer. Such chain transfer agents include halogenated compounds that result in bound halogen at one or both ends of the polymer chains. Example chain transfer agents of utility include methylene iodide, 1,4-diiodoperfluoro-n-butane, 1,6-diiodo-3,3,4,4-tetrafluorohexane, 1,3-diiodoperfluoropropane, 1,6-diiodoperfluoro-n-hexane, 1,3-diiodo-2-chloroperfluoropropane, 1,2-di(iododifluoromethyl)perfluorocyclobutane, monoiodoperfluoroethane, monoiodoperfluorobutane, 2-iodo-1-hydroperfluoroethane, 1-bromo-2-iodoperfluoroethane, 1-bromo-3-iodoperfluoropropane, and 1-iodo-2-bromo-1,1-difluoroethane. Preferred are chain transfer agents containing both iodine and bromine.

Fluoroelastomers containing cure sites can be prepared by polymerization of the appropriate monomer mixtures with the aid of a free radical initiator either in bulk, in solution in an inert solvent, in aqueous emulsion or in aqueous suspension. The polymerizations may be carried out in continuous, batch, or in semi-batch processes. General polymerization processes of utility are discussed in the aforementioned Moore Fluoroelastomers Handbook. General fluoroelastomer preparative processes are disclosed in U.S. Pat. Nos. 4,281,092; 3,682,872; 4,035,565; 5,824,755; 5,789,509; 3,051,677; and 2,968,649.

Examples of fluoroelastomers containing cure sites include: copolymers of cure site monomer, vinylidene fluoride, hexafluoropropylene and, optionally, tetrafluoroethylene; copolymers of cure site monomer, vinylidene fluoride, hexafluoropropylene, tetrafluoroethylene and chlorotrifluoroethylene; copolymers of cure site monomer, vinylidene fluoride, perfluoro(alkyl vinyl ether) and, optionally, tetrafluoroethylene; copolymers of cure site monomer, tetrafluoroethylene, propylene and, optionally, vinylidene fluoride; and copolymers of cure site monomer, tetrafluoroethylene and perfluoro(alkyl vinyl ether), preferably perfluoro(methyl vinyl ether). Fluoroelastomers containing polymerized units arising from vinylidene fluoride are preferred. In one embodiment, fluoroelastomer comprises copolymerized units of cure site monomer, vinylidene fluoride, hexafluoropropylene, and tetrafluoroethylene.

Fluoroelastomers comprising ethylene, tetrafluoroethylene, perfluoro(alkyl vinyl ether) and a bromine-containing cure site monomer, such as those disclosed by Moore, in U.S. Pat. No. 4,694,045, are of utility in the compositions of the present invention. Also of utility are the VITON® GF-series fluoroelastomers, for example VITON® GF-200S, available from DuPont Performance Elastomers, DE, USA.

Another component of the uncured composition is at least one multiolefinic crosslinker. By “multiolefinic” it is meant that it contains at least two carbon-carbon double bonds that are not in conjugation with one another. Multiolefinic crosslinker is present in the uncured composition in an amount of from about 1 to about 25 parts by weight per 100 parts by weight cross-linkable polymer (phr), preferably from about 1 to about 10 phr. Multiolefinic crosslinkers of utility include those containing acrylic (e.g., acryloyloxy, methacryloyloxy) and allylic functional groups.

A preferred multiolefinic crosslinker is non-fluorinated multiolefinic crosslinker. By “non-fluorinated” is meant that it contains no covalently bonded fluorine atoms.

Acrylic multiolefinic crosslinkers include those represented by the formula R(OC(═O)CR′═CH₂)ₙ, wherein: R is linear or branched alkylene, linear or branched oxyalkylene, aromatic, aromatic ether, or heterocyclic; R′ is H or CH₃; and n is an integer from 2 to 8. Representative polyols from which acrylic multiolefinic crosslinkers can be prepared include: ethylene glycol, propylene glycol, triethylene glycol, trimethylolpropane, tris-(2-hydroxyethyl) isocyanurate, pentaerythritol, ditrimethylolpropane and dipentaerythritol. Representative acrylic multiolefinic crosslinkers include 1,3-butylene glycol di(meth)acrylate, 1,6-hexanediol di(meth)acrylate, neopentyl glycol di(meth)acrylate, polyethylene glycol di(meth)acrylate, polypropylene glycol di(meth)acrylate, ethoxylated bisphenol A di(meth)acrylate, propoxylated bisphenol A di(meth)acrylate, alkoxylated cyclohexane dimethanol di(meth)acrylate, cyclohexane dimethanol di(meth)acrylate, trimethylolpropane tri(meth)acrylate, ethoxylated trimethylolpropane tri(meth)acrylate, propoxylated trimethylolpropane tri(meth)acrylate, bistrimethylolpropane tetra(meth)acrylate, tris(2-hydroxy ethyl)isocyanurate tri(meth)acrylate, pentaerythritol tri(meth)acrylate, pentaerythritol tetra(meth)acrylate, ethoxylated glycerol tri(meth)acrylate, propoxylated glycerol tri(meth)acrylate, pentaerythritol tetra(meth)acrylate, ethoxylated pentaerythritol tetra(meth)acrylate, propoxylated pentaerythritol tetra(meth)acrylate, dipentaerythritol penta(meth)acrylate, dipentaerythritol hexa(meth)acrylate, and combinations thereof. Herein, the designation “(meth)acrylate” is meant to encompass both acrylate and methacrylate.

Allylic multiolefinic crosslinkers include those represented by the formula R(CH₂CR′═CH₂)ₙ, wherein R is linear or branched alkylene, linear or branched oxyalkylene, aromatic, aromatic ether, aromatic ester or heterocyclic; R′ is H or CH₃; and n is an integer from 2 to 6. Representative allylic multiolefinic crosslinkers include 1,3,5-triallyl isocyanurate, 1,3,5-triallyl cyanurate, and triallyl benzene-1,3,5-tricarboxylate.

In the embodiment where UV curing is used to cure the uncured composition, a mixture of acrylic multiolefinic crosslinker and allylic multiolefinic crosslinker is of utility. For example, a weight ratio mixture of from about 2:1 to about 1:2, preferably about 1:1, of acrylic to allylic multiolefinic crosslinkers. In this embodiment, the acrylic crosslinker is preferably alkoxylated polyol polyacrylate, especially ethoxylated (3 mol) trimethylolpropane triacrylate, and the allylic crosslinker is preferably 1,3,5-triallyl isocyanurate.

In one embodiment of uncured composition: the cross-linkable polymer is fluoroelastomer having at least one cure site selected from the group consisting of bromine and iodine, preferably iodine; the multiolefinic crosslinker is an allylic multiolefinic crosslinker, preferably 1,3,5-triallyl isocyanurate; the uncured composition contains no acrylic multiolefinic crosslinker; the nanosilica comprises a plurality of solid and hollow nanosilica particles; the oxysilane, comprises acryloxypropyltrimethoxysilane (APTMS) and at least one of a hydrolysis and condensation product of APTMS; the uncured composition contains photoinitiator; the uncured composition contains polar aprotic organic solvent; and UV curing is used.

In one embodiment, oxysilane and nanosilica are combined at substantially the same time with the other components of the uncured composition. In another embodiment, oxysilane and nanosilica are combined to form a composite prior to combining with the other components of the uncured composition.

In one embodiment, present low refractive index compositions are reaction products that include as one component a nanosilica composite comprising: (a) a plurality of solid nanosilica particles; (b) a plurality of porous nanosilica particles; and (c) an oxysilane having at least one polymerizable functional group and at least one of a hydrolysis and condensation product of APTMS. Use of solid nanosilica particles and porous nanosilica particles results in low refractive index compositions having lowered refractive index and increased abrasion resistance over those in which solid nanosilica particles or hollow nanosilica particles are used alone.

Nanosilica particles of utility can be any shape, including spherical and oblong, and are relatively uniform in size and remain substantially non-aggregated during formation of the low refractive index composition. Aggregation of the nanosilica particles prior to or during formation of the uncured composition can undesirably result in precipitation, gelation, and a dramatic increase in sol viscosity that may make uniform coatings difficult to achieve. Nanosilica particles may aggregate to form aggregate particles in the colloid prior to or during formation of the nanosilica composite, wherein each of the aggregate particles comprises a plurality of smaller sized nanoparticles. The average aggregate nanosilica particle diameter in the colloid is desirably less than about 90 nm before coating, but can be larger than 90 nm.

Solid nanosilica particles of utility for forming the present low refractive index composition have a d₅₀ of from about 5 nm to about 90 nm, preferably from about 5 nm to about 60 nm. Solid nanosilica particles can be produced from sols of silicon oxides (e.g., colloidal dispersions of solid silicon nanoparticles in liquid media), especially sols of amorphous, semi-crystalline, and/or crystalline silica. Such sols can be prepared by a variety of techniques and in a variety of forms, which include hydrosols (i.e., where water serves as the liquid medium), organosols (i.e., where organic liquids serves as the liquid medium), and mixed sols (i.e., where the liquid medium comprises both water and an organic liquid). See, e.g., descriptions of the techniques and forms disclosed in U.S. Pat. Nos. 2,801,185, 4,522,958 and 5,648,407.

Porous nanosilica particles of utility for forming the present low refractive index composition have a d₅₀ of from about 5 nm to about 90 nm, preferably from about 5 nm to about 70 nm. Porous nanosilica particles substantially reduce the refractive index of the present nanosilica composite, and thus reduce the refractive index of the present low refractive index composition. Of utility are porous nanosilica particles having refractive index of from about 1.15 to about 1.40, preferably from about 1.20 to about 1.35. Refractive index as used here in this context refers to the refractive index of the particle as a whole. Porous nanosilica particles can have pores of any shape, provided that such pores are not of a dimension that allows higher refractive index components present in the uncured composition to enter the pores. One example is where the pore comprises a void of lower density and low refractive index (e.g., a void containing air) formed within a shell of silicon oxide, i.e., a hollow nanosilica particle. The thickness of the nanoparticle shell affects the strength of the nanoparticles. As hollow nanosilica particle is rendered to have reduced refractive index and increased porosity, the thickness of the shell decreases resulting in a decrease in the strength (i.e., fracture resistance) of the nanoparticles. Porous nanosilica particles having a refractive index lower than about 1.15 are undesirable, as such particles will have unacceptable strength. Assuming that the radius of the void inside a particle is x and the radius of the outer shell of the particle is y, the porosity (P) as represented by the formula P=(4πx³/3)/(4πy³/3)×100 is generally from about 10% to about 60%, and preferably from about 30% to about 60%.

Methods for producing such hollow nanosilica particles are known, for example, as described in JP-A-2001/233611 and JP-A-2002/79616.

In the embodiment where a nanosilica sol of utility for forming a present low refractive index composition is produced in a protic solvent (e.g., water, alcohol), it is necessary to replace at least 90 volume % of such protic solvent with an aprotic solvent before the sol is used in formation of the present low refractive index composition. Preferably at least 97 volume % of such protic solvent is replaced with an aprotic solvent before the sol is used in formation of the present low refractive index composition. Methods for such solvent replacement are known, for example, distillation under reduced pressure. Solid nanosilica particles are commercially available as colloidal dispersions or sols dispersed in polar aprotic solvents, for example the product known as “Nissan MEK-ST”, a solid silica colloid in methyl ethyl ketone, median particle diameter d₅₀ of about 16 nm, 30-31 wt % silica, commercially available from Nissan Chemicals America Corporation, Houston, Tex., USA. Hollow nanosilica particles are commercially available as colloidal dispersions or sols dispersed in polar aprotic solvents, for example, the product known as “SKK Hollow Nanosilica”, “ELCOM” grade hollow nanosilicon oxide colloid in methyl isobutyl ketone, average particle size about 41 nm, about 20.3 wt % silica, commercially available from Shokubai Kasei Kogyo Kabushiki Kaisha, Japan.

The sum of the volume percent of solid nanosilica particles and the volume percent of porous nanosilica particles is less than or equal to about 45, generally from about 10 to about 30. The volume percent of solid nanosilica particles is greater than 0 and less than or equal to about 20, generally about 5 to about 20. The total volume percent of solid and porous nanosilica particles is preferably at least about 10 volume percent. The volume percent of nanosilica particles is herein defined as 100 times the quotient of the volume of dry nanosilica particles divided by the sum of the volumes of dry cross-linkable polymer, multiolefinic crosslinker, solid nanosilica particles and porous nanosilica particles. In the embodiment where the uncured composition additionally comprises components that remain in the low refractive index composition in some form after curing, the sum in the denominator additionally includes the volume of such dry components. For example in the embodiment where the uncured composition contains initiator as well as cross-linkable polymer, multiolefinic crosslinker, solid nanosilica particles and porous nanosilica particles, the volume percent of nanosilica particles is 100 times the quotient of the volume of dry nanosilica particles divided by the sum of the volumes of dry cross-linkable polymer, multiolefinic crosslinker, solid nanosilica particles, porous nanosilica particles, and initiator.

Solid nanosilica particles and porous nanosilica particles can be used together in forming the present low refractive index composition in any proportion within the aforementioned volume percentage ranges. Generally, an about 0.1:1 to about 4:1 ratio of volume percent solid nanosilica particles to volume percent porous nanosilica particles is of utility.

Solid nanosilica particles and hollow nanosilica particles of any aforementioned median diameter d₅₀ can be used together in forming the present nanosilica composite.

In one embodiment, the solid nanosilica particles have at least about 20% but less than 100% of the reactive silanols functionalized with an unreactive substituent. In one embodiment, the solid nanosilica particles have at least about 50% but less than 100% of the reactive silanols functionalized with an unreactive substituent. In one embodiment, the solid nanosilica particles have at least about 75% but less than 100% of the reactive silanols functionalized with an unreactive substituent. In one embodiment, the solid nanosilica particles have at least about 90% but less than 100% of the reactive silanols functionalized with an unreactive substituent. By reactive silanols is meant silanols on the surface of the nanosilica particles prior to functionalization that are available to react as nucleophiles. By functionalized with an unreactive substituent is meant that such functionalized silanols are bonded to substituents that do not allow reaction of the functionalized silanols with any component of the uncured composition. By unreactive substituent is meant a substituent that is not reactive towards any component of the uncured composition. Unreactive substituents of utility include trialkylsilyl, for example, trimethylsilyl.

Characterization of the extent to which solid nanosilica reactive silanols are substituted with unreactive substituents can be carried out by known methods. For example, the use of gas phase titration of the nanosilica using pyridine as a probe with monitoring by DRIFTS (diffuse reflectance infrared Fourier transform spectroscopy) allows for the characterization of the extent to which the solid nanosilica particle reactive silanols are substituted with unreactive substituents.

Oxysilanes of utility in forming the present low refractive index composition are compounds comprising: i) a polymerizable functional group, ii) an oxysilane functional group, and iii) a divalent organic radical connecting the polymerizable functional group and the oxysilane functional group. Oxysilane can be represented by the formula X—Y—SiR¹R²R³. X represents a polymerizable functional group, for example, an acryloyloxy group (CH₂═CHC(═O)O—), methacryloyloxy group (CH₂═C(CH₃)C(═O)O—) or epoxy group. X is preferably an acryloyloxy group or methacryloyloxy group, most preferably an acryloyloxy group. Y represents a divalent organic radical covalently bonded to the polymerizable functional group and the oxysilane functional group. Example Y radicals include substituted and unsubstituted alkylene groups having 2 to 10 carbon atoms, and substituted or unsubstituted arylene groups having 6 to 20 carbon atoms. The alkylene and arylene groups optionally additionally have ether, ester and amide linkages therein. Substituents include halogen, hydroxyl, mercapto, carboxyl, alkyl and aryl. SiR¹R²R³ represents an oxysilane functional group containing three substituents (R¹⁻³), one to all of which are capable of being displaced by (e.g., nucleophilic) substitution. For example, at least one of the R¹⁻³ substituents are alkoxy, aryloxy or halogen and the substituting group comprises a group such as hydroxyl present on an oxysilane hydrolysis or condensation product, or equivalent reactive functional group present on a substrate film surface. Representative SiR¹R²R³ oxysilane substitution includes where R¹ is C₁-C₂₀ alkoxy, C₆-C₂₀ aryloxy, or halogen, and R² and R³ are independently selected from C₁-C₂₀ alkoxy, C₆-C₂₀ aryloxy, C₁-C₂₀ alkyl, C₆-C₂₀ aryl, C₇-C₃₀ aralkyl, C₇-C₃₀ alkaryl, halogen, and hydrogen. R¹ is preferably C₁-C₄ alkoxy, C₆-C₁₀ aryloxy, or halogen. Example oxysilanes include: acryloxypropyltrimethoxysilane (H₂C═CHCO₂(CH₂)₃Si(OCH₃)₃, herein also referred to as APTMS), acryloxypropyltriethoxysilane, acryloxypropylmethyldimethoxysilane, methacryloxypropyltrimethoxysilane, methacryloxypropyltriethoxysilane, and methacryloxypropylmethyldimethoxysilane. Preferred amongst oxysilanes is APTMS.

At least one of a hydrolysis and condensation product of the oxysilane is present with the oxysilane in uncured compositions of utility for forming the present low refractive index composition. By oxysilane hydrolysis product is meant compounds in which at least one of the oxysilane R¹−3 substituents has been replaced by hydroxyl. For example, X—Y—SiR₂OH. By oxysilane condensation product is meant a product formed by condensation reaction of one or more oxysilane and/or oxysilane hydrolysis products. For example, condensation products such as: X—Y—Si(R¹)(R²)OSi(R¹)(OH)—Y—X; X—Y—Si(R¹)(OH)OSi(R¹)(OH)—Y—X; X—Y—Si(OH)₂OSi(R¹)(OH)—Y—X; X—Y—Si(R¹)(OH)OSi(R¹)(OSi(R¹)(OH)—Y—X)—Y—X; and X—Y—Si(R¹)(R²)OSi(R¹)(OSi(R¹)(OH)—Y—X)—Y—X.

The relative amount of oxysilane and solid nanosilica particles of utility for forming the present low refractive index composition is from about 0.3 to about 20, preferably from about 1.5 to about 14, more preferably from about 2.5 to about 14 molecules oxysilane on average per square nanometer of solid nanosilica particle surface area. The relative amount of oxysilane and porous nanosilica particles of utility for forming the present low refractive index composition is from about 0.4 to about 30, preferably from about 2.0 to about 15, more preferably from about 3.0 to about 12 molecules oxysilane on average per square nanometer of porous nanosilica particle surface area.

In practice, the weight in grams (L) of oxysilane needed to achieve a chosen number of molecules of oxysilane per square nanometer of nanosilica particle surface area can be determined by the equation:
L=(I×A×K×5×10⁻³)÷(R×D)
wherein:
I=chosen number of molecules of oxysilane per square nanometer of nanosilica particle surface area;
A=dry weight in grams of the nanosilica particles;
K=molecular weight in g/mol of the oxysilane;
R=median radius in nm of the nanosilica particles; and
D=density in g/cm³ of the dry nanosilica particles.
   The median radius in nm of the nanosilica particles is determined from electron micrographs of the nanosilica particles prior to formation of a present oxysilane and nanosilica composite or low refractive index composition. To determine the median radius, a transmission electron micrograph negative of a large field of nanosilica particles is scanned to produce a digital image. A SUN workstation running Khoros 2000 software is used to analyze the digital image and obtain the particle size distribution therefrom. Typically, several hundred nanosilica particles are analyzed, and a median particle radius of the nanosilica particles approximated as spheres is calculated.

In one embodiment, a nanosilica composite of utility in forming an uncured composition is formed by combining the aforementioned solid nanosilica particles, porous nanosilica particles and oxysilane. For example, combining a solid nanosilica particle sol, a porous nanosilica particle sol, and oxysilane, optionally in the presence of polar aprotic solvent while heating forms a nanosilica composite. The method of such combining is not critical, and includes weighing out desired amounts of each component followed by mixing together in a vessel. The resultant nanosilica composite dispersion in solvent can be combined with other components comprising the uncured composition.

In one embodiment, and uncured composition of utility in forming a low refractive index composition of the present invention can be formed, and maintained prior to being coated on a substrate as well as during curing, substantially free of compounds capable of catalyzing the hydrolysis of the oxysilane (i.e., hydrolysis catalyst). Hydrolysis catalyst refers to any compound besides nanosilica that can catalyze the hydrolysis of any of the oxysilane substituents R¹⁻³. For example, hydrolysis catalyst includes inorganic acids such as hydrochloric acid, sulfuric acid, and nitric acid; organic acids such as oxalic acid, acetic acid, formic acid, methanesulfonic acid, and toluene sulfonic acid; inorganic bases such as sodium hydroxide, potassium hydroxide and ammonia; organic bases such as trialkylamines and pyridine; and metal chelates and metal alkoxides such as triisopropoxyaluminum and tetrabutoxyzirconium. Such hydrolysis catalysts can catalyze the displacement of oxysilane substituents such as alkoxy, aryloxy or halogen by water, resulting in the formation of hydroxyl (silanol) groups in their place. Relative to this embodiment, “substantial absence” and “substantially free” means that the referenced composition contains about 0.02% by weight or less, of hydrolysis catalyst. Optionally within this embodiment, the referenced composition contains about 8% by weight or less of protic compounds. Where the protic compound is water, the referenced composition optionally contains about 1.5% by weight or less, and even about 0.5% by weight or less, of water.

In one embodiment no special precaution is taken to exclude hydrolysis catalyst or protic compounds such as water during and after coating of the uncured composition on a substrate and formation of the present low refractive index reaction product by curing of an uncured composition.

The present low refractive index composition has a refractive index of from about 1.20 to about 1.49, preferably from about 1.30 to 1.44.

The term uncured composition as used herein refers to a mixture comprising at least one component that is cured or reacted to form the present low refractive index composition. Components of the uncured composition include cross-linkable polymer, multiolefinic cross linker, solid nanosilica particles, porous nanosilica particles, oxysilane having at least one polymerizable functional group, and at least one of a hydrolysis and condensation product of said oxysilane, and free radical polymerization initiator. Uncured composition can further comprise unreactive components such as polar aprotic solvent to facilitate handling and coating.

Polymerizable functional groups on oxysilane and hydrolysis and condensation products of the oxysilane do not react with other components of the uncured composition under ambient conditions. However, when the uncured composition is exposed to at least one of energy (e.g., heat, light) and chemical treatment (e.g., peroxide free radical polymerization initiators), the polymerizable functional groups will polymerize as well as react with other components of the uncured composition, for example, functionality on the cross-linkable polymer (e.g., cure sites), multiolefinic crosslinker, as well as functionality present on the surface of a substrate film on which the uncured composition is coated. In one embodiment, and oxysilane and nanosilica composite can be incorporated with other uncured composition reactive components without causing the uncured composition reactive components to react (crosslink) prior to curing.

In one embodiment a nanosilica sol containing greater than 0% water is combined with an oxysilane to form a composite or uncured composition. The composite or uncured composition can be allowed to age at room or elevated temperature. For example, nanosilica can be contacted with oxysilane to form a composite which is allowed to age at room or elevated temperature for a period of time of from about 1 hours to about 7 days. Such ageing allows for hydrolysis of at least a portion of the oxysilane to occur and allows for formation of at least one of a hydrolysis and condensation product of the oxysilane. In the embodiment where the composite or uncured composition is aged at an elevated temperature, for example at a temperature of about 90° C. or at about the reflux temperature of the solvent for the mixture, the ageing period can be shorter than the aforementioned, for example from about 1 to about 12 hours.

In one embodiment, composites of nanosilica with oxysilane can be formed separately and allowed to age separately. In one embodiment, a composite comprising both solid and porous nanosilica and oxysilane can be formed and allowed to age. In each such embodiment, the composite can be allowed to age at room temperate or at an elevated temperature prior to combination with other components of the uncured composition.

In one embodiment the oxysilane and nanosilica are combined at substantially the same time with the other components of the uncured composition and the resultant uncured composition is allowed to age at room or an elevated temperature prior to coating and curing.

Uncured compositions are cured to form the present low refractive index compositions. The uncured compositions can be cured by a free radical initiation mechanism. Free radicals may be generated by known methods such as by the thermal decomposition of organic peroxides, azo compounds, persulfates, redox initiators, and combinations thereof, optionally included in the uncured composition, or by radiation such as ultraviolet (UV) radiation, gamma radiation, or electron beam radiation, in the presence of a photoinitiator. The uncured compositions preferably contain at least one photoinitiator and are cured via irradiation with UV radiation.

In an embodiment where UV radiation initiation is used to cure and uncured composition according to the present invention, the uncured composition includes photoinitiator, generally between 1 and 10 phr, preferably between 5 and 10 phr of photo-initiator. Photoinitiators can be used singly or in combinations of two or more. Free-radical photoinitiators of utility include those known as having utility in UV curing acrylate polymers. Example photoinitiators of utility include benzophenone and its derivatives; benzoin, alpha-methylbenzoin, alpha-phenylbenzoin, alpha-allylbenzoin, alpha-benzylbenzoin; benzoin ethers such as benzil dimethyl ketal (commercially available as Irgacure® 651 (Irgacure® products available from Ciba Specialty Chemicals Corporation, Tarrytown, N.Y., USA)), benzoin methyl ether, benzoin ethyl ether, benzoin n-butyl ether; acetophenone and its derivatives such as 2-hydroxy-2-methyl-1-phenyl-1-propanone (commercially available as Darocur® 1173 (Darocur® products available from Ciba Specialty Chemicals Corporation, Tarrytown, N.Y., USA)) and 1-hydroxycyclohexyl phenyl ketone (commercially available as Irgacure® 184); 2-methyl-1-[4-methylthio)phenyl]-2-(4-morpholinyl)-1-propanone (commercially available as Irgacure® 907); alkyl benzoyl formates such as methylbenzoylformate (commercially available as Darocur® MBF); 2-benzyl-2-(dimethylamino)-1-[4-(4-morpholinyl)phenyl]-1-butanone (commercially available as Irgacure® 369); aromatic ketones such as benzophenone and its derivatives and anthraquinone and its derivatives; onium salts such as diazonium salts, iodonium salts, sulfonium salts; titanium complexes such as, for example, that which is commercially available as “CGI 784 DC”, also from Ciba Specialty Chemicals Corporation; halomethylnitrobenzenes; and mono- and bis-acylphosphines such as those available from Ciba Specialty Chemicals Corporation under the trade designations Irgacuree 1700, Irgacure® 1800, Irgacure® 1850, Irgacure® 819, Irgacure® 2005, Irgacure® 2010, Irgacure® 2020 and Darocur® 4265. Further, sensitizers such as 2- and 4-isopropyl thioxanthone, commercially available from Ciba Specialty Chemicals Corporation as Darocur® ITX, may be used in conjunction with the aforementioned photoinitiators.

Photoinitiators are typically activated by incident light having a wavelength between about 254 nm and about 450 nm. The uncured composition can be cured by light from a high pressure mercury lamp having strong emissions around wavelengths 260 nm, 320 nm, 370 nm and 430 nm. In one embodiment a combination of at least one photoinitiator with relatively strong absorption at shorter wavelengths (i.e., 245-350 nm), and at least one photoinitiator with relatively strong absorption at longer wavelengths (i.e., 350-450 nm) to cure the present uncured compositions. Such a photoinitiator mixture results in the most efficient usage of energy emanating from a UV light source. Example photoinitiators with relatively strong absorption at shorter wavelengths include benzil dimethyl ketal (e.g., Irgacure® 651) and methylbenzoyl formate (e.g., Darocur® MBF). Example photoinitiators with relatively strong absorption at longer wavelengths include 2- and 4-isopropyl thioxanthone (e.g., Darocur® ITX). An example such mixture of photoinitiators is a 10 parts by weight of a 2:1 weight ratio mixture of Irgacure® 651 and Darocur® MBF, to 1 part by weight of Darocure ITX.

Thermal initiators may also be used together with photoinitiator when UV curing. Useful thermal initiators in this instance include, for example, azo, peroxide, persulfate and redox initiators.

UV curing of present uncured compositions can be carried out in the substantial absence of oxygen, which can negatively influence the performance of certain UV photoinitiators. To exclude oxygen, UV curing can be carried out under an atmosphere of inert gas such as nitrogen.

UV curing of present uncured compositions can be carried out at ambient temperature, but also can be carried out at an elevated temperature of from about 60° C. to about 85° C., preferably about 75° C. Carrying out UV curing at an elevated temperature results in a more complete cure.

In an embodiment where thermal decomposition of organic peroxide is used to generate free radicals to cure an uncured composition according to the present invention, the uncured composition generally includes between 1 and 10 phr, preferably between 5 and 10 phr of organic peroxide. Useful free-radical thermal initiators include, for example, azo, peroxide, persulfate, and redox initiators, and combinations thereof. Organic peroxides are preferred, and example organic peroxides include: 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydrbxyperoxide; di-t-butyl peroxide; t-butylcumyl peroxide; dicumyl peroxide; alpha,alpha′-bis(t-butylperoxy-m-isopropyl)benzene; 2,5-dimethyl-2,5-di(t-butylperoxy)hexane; 2,5-dimethyl-2,5-di(t-butylperoxy)hexene-3; benzoyl peroxide; t-butylperoxybenzene; 2,5-dimethyl-2,5-di(benzoylperoxy)-hexane; t-butylperoxymaleic acid; and t-butylperoxyisopropylcarbonate. Preferred is benzoyl peroxide. Organic peroxides may be used singly or in combinations of two or more.

Uncured compositions of utility in forming low refractive index compositions according to the present invention optionally contains unreactive components, such as solvent to facilitate coating as well as handling and transfer. Thus, further included is a liquid mixture for forming a low refractive index coating, the liquid mixture comprising: a solvent having dissolved therein: (i) a cross-linkable polymer; (ii) a multiolefinic crosslinker; (iii) an oxysilane having at least one polymerizable functional group and at least one of a hydrolysis and condensation product of said oxysilane; (iv) a free radical polymerization initiator; and wherein the solvent has suspended therein: (v) a plurality of solid nanosilica particles; and (vi) a plurality of porous nanosilica particles; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles.

Solvent can be included in the uncured composition to reduce the viscosity of the uncured composition in order to facilitate coating. The appropriate viscosity of uncured composition containing solvent depends upon various factors such as the desired thickness of the anti-reflective coating, application technique, and the substrate onto which the uncured composition is to be applied, and can be determined by one of ordinary skill in this field without undue experimentation. Generally, the amount of solvent in the uncured composition is about 10 weight % to about 60 weight %, preferably from about 20 weight % to about 40 weight %, based on the total weight of all components in the uncured composition.

Solvent is selected such that it does not adversely affect the curing properties of the uncured composition or attack the optical display substrate. Additionally, solvent is chosen such that the addition of the solvent to the uncured composition does not result in flocculation of the nanosilica particles. Furthermore, the solvent should be selected such that it has an appropriate drying rate. That is, the solvent should not dry too slowly, which can undesirably delay the process of making an anti-reflective coating from the uncured composition. It should also not dry too quickly, which can cause defects such as pinholes or craters in the resultant anti-reflective coating. Solvents of utility include polar aprotic organic solvents, and representative examples include aliphatic and alicyclic: ketones such as methyl ethyl ketone and methyl isobutyl ketone; esters such as propyl acetate; ethers such as di-n-butyl ether; and combinations thereof. Preferred solvents include propyl acetate and methyl isobutyl ketone. Lower alkyl hydrocarbyl alcohols (e.g., methanol, ethanol, isopropanol, etc.) can be present as a components of the solvent, but should comprise about 8% or less by weight of the solvent when the cross-linkable polymer is fluoroelastomer having at least one cure site selected from the group consisting of bromine, iodine and ethenyl.

Further included is a method for forming a stratified anti-reflective coating on a substrate comprising:

(i) preparing a liquid mixture comprising a solvent having dissolved therein:
(1) a cross-linkable polymer;
(2) a multiolefinic crosslinker;
(3) an oxysilane having at least one polymerizable functional group and at least one of a hydrolysis and condensation product of said oxysilane; and
(4) a free radical polymerization initiator;

and wherein the solvent has suspended therein:
(5) a plurality of solid nanosilica particles;
(6) a plurality of porous nanosilica particles; and; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles;

(ii) applying a coating of the liquid mixture on a substrate to form a liquid mixture coating on the substrate;

(iii) removing solvent from the liquid mixture coating to form an uncured coating on the substrate; and

(iv) curing the uncured coating thereby forming a anti-reflective coating on said substrate.

In one embodiment, the method for forming the anti-reflective coating results in the plurality of solid nanosilica particles being located within the antireflective coating substantially adjacent to the substrate.

In one embodiment, the preparing of the liquid mixture is carried out in the substantial absence of compounds capable of catalyzing the hydrolysis of the oxysilane.

The present method includes a step of coating the liquid mixture on an optical display substrate to form a liquid mixture coating on the substrate. In one embodiment, the step of coating can be carried out in a single coating step. Coating techniques useful for applying the uncured composition onto the substrate in a single coating step are those capable of forming a thin, uniform layer of liquid on a substrate, such as microgravure coating, for example, as described in US patent publication no. 2005/18733.

The present method includes a step of removing the solvent from the liquid mixture coating on the substrate to form an uncured coating on the substrate. The solvent can be removed by known methods, for example, heat, vacuum and a flow of inert gas in proximity to the coated liquid mixture on the substrate.

The present method includes a step of curing the uncured coating. As discussed previously herein, the uncured coating is can be cured by a free radical initiation mechanism. Free radicals can be generated by known methods such as by the thermal decomposition of an organic peroxide or by radiation such as ultraviolet (UV) radiation, gamma radiation, or electron beam radiation. Present uncured compositions are preferably UV cured due to the relative low cost and speed of this curing technique when applied on an industrial scale.

The cured low refractive index anti-reflective coating has a thickness less than about 120 nm and greater than about 80 nm, preferably less than about 110 nm and greater than about 90 nm, and more preferably about 100 nm.

The present invention further includes an article comprising a substrate having an anti-reflective coating, wherein said coating comprises the reaction product of: (i) a cross-linkable polymer; (ii) a multiolefinic crosslinker; (iii) a plurality of solid nanosilica particles; (iv) a plurality of porous nanosilica particles; and (v) an oxysilane having at least one polymerizable functional group, and at least one of a hydrolysis and condensation product of said oxysilane; and (vi) a free radical polymerization initiator; wherein the volume percent of the solid nanosilica particles is greater than 0 and less than or equal to about 20; the sum of the volume percent of the solid nanosilica particles and the volume percent of the porous nanosilica particles is less than or equal to about 45; and wherein volume percent is based on the sum of the dry volumes of the cross-linkable polymer, the multiolefinic crosslinker, the solid nanosilica particles and the porous nanosilica particles.

In one embodiment, the plurality of solid nanosilica particles and plurality of porous nanosilica particles are located within the antireflective coating substantially adjacent to the substrate.

Substrates having an anti-reflective coating according to the present invention find use as display surfaces, optical lenses, windows, optical polarizers, optical filters, glossy prints and photographs, clear polymer films, and the like. Substrates may be either transparent or anti-glare and include acetylated cellulose (e.g., triacetyl cellulose (TAC)), polyester (e.g., polyethylene terephthalate (PET)), polycarbonate, polymethylmethacrylate (PMMA), polyacrylate, polyvinyl alcohol, polystyrene, glass, vinyl, nylon, and the like. Preferred substrates are TAC, PET, and PMMA. The substrates optionally have a hardcoat applied between the substrate and the anti-reflective coating, such as but not limited to an acrylate hardcoat. The substrates optionally have an antistat agent or layer applied between the hardcoat and the anti-reflective coating.

As used herein, the terms “specular reflection” and “specular reflectance” refer to the reflectance of light rays into an emergent cone with a vertex angle of about 2 degrees centered around the specular angle. The terms “diffuse reflection” or “diffuse reflectance” refer to the reflection of rays that are outside the specular cone defined above. The specular reflectance for the present low refractive index compositions on transparent substrates is about 2.0% or less, preferably about 1.7% or less.

Antireflective coatings of the present low refractive index compositions on the aforementioned substrates have exceptional resistance to abrasion. The scratched percent of the low refractive index compositions is less than or equal to 10%, preferably less than or equal to 5% as determined by Method 4 after abrasion by Method 1. The present invention includes an anti-reflective coating having Rvis less than about 1.3% and a scratched percent less than or equal to 10, preferably less than or equal to 7, as determined by Method 4 after abrasion by Method 1.

### EXAMPLES

### Key

APTMS: acryloxypropyltrimethoxysilane, oxysilane (Aldrich, 92%)

Darocur® ITX: mixture of 2-isopropylthioxanthone and 4-isopropylthioxanthone, photoinitiator available from Ciba Specialty Chemicals, Tarrytown, N.Y., USA

Genocure® MBF: methlybenzoylformate, photoinitiator available from Rahn USA Co., IL, USA

Irgacure® 651: 2,2-dimethoxy-1,2-diphenylethane-1-one, photoinitiator available from Ciba Specialty Chemicals, Tarrytown, N.Y., USA

Irgacure® 907: 2-methyl-1[4-(methylthio)phenyl]-2-morpholinopropan-1-one, photoinitiator available from Ciba Specialty Chemicals, Tarrytown, N.Y., USA

Nissan MEK-ST: silica colloid in methyl ethyl ketone containing 0.5 wt % water, median particle diameter d₅₀ of about 10-16 nm, about 30 wt % silica, available from Nissan Chemical America Co., Houston, Tex., USA. Examination of Nissan MEK-ST by solid state ²⁹Si and ¹³C NMR (nuclear magnetic resonance) spectroscopy reveals that the surface (reactive silanols) of the MEK-ST nanosilica particles is functionalized with trimethylsilyl substituents.

Characterization of the Extent to which Nissan MEK-ST Solid Nanosilica Reactive Silanols are Substituted with Trimethylsilyl Substituents:

Characterization of the extent to which solid nanosilica reactive silanols are substituted with unreactive substituents can be performed by DRIFTS (diffuse reflectance infrared Fourier transform spectroscopy). Characterization of the extent to which Nissan MEK-ST solid nanosilica reactive silanols are substituted with unreactive trimethylsilyl substituents is performed by DRIFTS as follows.

The solvent in the nanosilica colloid is removed by evaporation at room temperature to produce the silicon oxide nanocolloid powder. DRIFTS measurements are made with the use of a Harrick ‘praying Mantis’ DRIFTS accessory in a Biorad FTS 6000 FTIR Spectrometer. Samples are diluted to a concentration of 10% in KCl for DRIFTS analysis. Grinding is avoided in preparing the dilutions to avoid changing the nature of the surface of the nanosilica. Data processing is performed using the GRAMS/32 spectroscopy software suite by Thermo Scientific. After baseline offset correction, the data is transformed using the Kubelka-Munk transform to linearize the response to sample concentration. Spectra are normalized to the height of the silica overtone band near 1874 cm⁻¹ in all comparisons to correct for slight differences in sample concentration. A sample of Nissan MEK-ST is compared with a sample of Nissan IPA-ST (Nissan IPA-ST is unfunctionalized Nissan MEK-ST in isopropyl alcohol). A DRIFTS spectrum is obtained on a sample. The sample is then introduced into a closed vessel containing an open container of APTMS and maintained in the vessel for 1 hour under standard conditions. Without disrupting the sample, a DRIFTS spectrum of the sample is then obtained. The band observed at about 3737 cm⁻¹ corresponds to reactive silanol groups. For Nissan IPA-ST, the intensity of this band is significantly reduced as a result of exposure of the sample to APTMS. Without wishing to be bound by theory, the present inventors believe that this is due to the unfunctionalized reactive silanols interacting with the APTMS. For Nissan MEK-ST, there is substantially no change in the intensity of this band as a result of exposure of the sample to APTMS. Without wishing to be bound by theory, the present inventors believe that this is due to the relative absence of reactive silanols on the surface of Nissan MEK-ST for the APTMS to interact with. Based on the integrated intensity of the reactive silanol band at 3737 cm⁻¹, which is derived on the Nissan IPA-ST sample, it is estimated that the reactive silanol coverage on the Nissan MEK-ST sample is less than 5% of the coverage that is observed on the Nissan IPA-ST sample. Therefore, approximately 95% or more of the reactive silanols on the surface of Nissan MEK-ST are substituted with an unreactive substituent (trimethylsilyl).

Sartomer SR454: ethoxylated trimethylolpropane triacrylate, non-fluorinated multiolefinic crosslinker available from Sartomer Co., Exton, Pa., USA

Sartomer SR533: triallyl isocyanurate, non-fluorinated multiolefinic crosslinker available from Sartomer Co., Exton, Pa., USA.

SKK Hollow Nanosilica: “ELCOM” grade hollow nanosilicon oxide colloid in methyl isobutyl ketone, median particle diameter d₅₀ of about 41 nm, about 20.3 wt % silica, available from Shokubai Kasei Kogyo Kabushiki Kaisha, Japan.

Viton® GF200S: copolymer of vinylidene fluoride, tetrafluoroethylene, hexafluoropropylene and a cure site monomer, a fluoroelastomer available from DuPont Performance Elastomers, DE, USA.

Methods

Method 1: Surface Abrasion

A 3.7 cm by 7.5 cm piece of substrate film coated with an anti-reflective coating of the present invention is mounted, with the coated surface up, onto the surface of a flat glass plate by fastening the edges of the film to the plate with adhesive tape. Liberon grade #0000 steel wool is cut into patches slightly larger than 1 by 1 cm. A soft (compliant) foam pad cut to 1 by 1 cm is placed over the steel wool pad and a 200-gram brass weight held in a slip fit Delrin® sleeve is placed on top of the foam pad. The sleeve is moved by a stepping motor driven translation stage model MB2509P5J-S3 CO18762. A VELMEX VXM stepping motor controller drives the stepping motor. The steel wool and weight assembly are placed on the film surface and rubbed back and forth over the film surface, for 10 cycles (20 passes) over a distance of 3 cm at a velocity of 5 cm/sec.

Method 2: Measurement of Specular Reflectance (R_{VIS})

A 3.7 cm×7.5 cm piece of substrate film coated with an anti-reflective coating of the present invention is prepared for measurement by adhering a strip of black PVC electrical tape (Nitto Denko, PVC Plastic tape #21) to the uncoated side of the film, in a manner that excludes trapped air bubbles, to frustrate the back surface reflections. The film is then held at normal to the spectrometer's optical path. The reflected light that is within about 2 degrees of normal incidence is captured and directed to an infra-red extended range spectrometer (Filmetrics, model F50). The spectrometer is calibrated between 400 nm and 1700 nm with a low reflectance standard of BK7 glass with its back surface roughened and blackened. The specular reflection is measured at normal incidence with an acceptance angle of about 2 degrees. The reflection spectrum is recorded in the range from 400 nm to 1700 nm with an interval of about 1 nm. A low noise spectrum is obtained by using a long detector integration time so that the instrument is at full range or saturated with about a 6% reflection. A further noise reduction is achieved by averaging 3 or more separate measurements of the spectrum. The reflectance reported from the recorded spectrum is the result of a color calculation of x, y, and Y where Y is reported as the specular reflectance (R_{VIS}). The color coordinate calculation is performed for a 10 degree standard observer with a type C light source.

Method 3: Haze

Haze is measured according to the method of ASTM D 1003, “Standard Test Method for Haze and Luminous Transmittance of Transparent Plastics”, using a “BYK Gardner Haze-Guard Plus” available from BYK-Gardner USA, Columbia, Md.

Method 4: Quantifying Surface Abrasion

The present Method involves imaging a film abraded by Method 1 and quantifying the scratched % area on the abraded film by software manipulation of the image.

No single image analysis procedure covering all possibilities exists. The average-skilled practitioner will understand that the image analysis performed is very specific. General guidance is given here with the understanding that unspecified parameters are within the ability of the average-skilled practitioner to discern without undue experimentation. This analysis assumes there are both “on axis” and “off axis” illumination of the sample and the image is taken in reflected light at about 7 degrees from normal incidence. It is also assumed that the scratches are in a vertical orientation in the image. Appropriate image contrast can be established without undue experimentation by the average-skilled practitioner. Image contrast is controlled by the lighting intensity, the camera white and dark reference settings, the index of refraction of the substrate, the index of refraction and the thickness of the low refractive index composition. Also to increase the contrast of the image a piece of black electrical tape is adhered to the back of the substrate. This has the effect of frustrating the back surface reflection.

The image used for analyzing the scratched area on the film generated by Method 1 is obtained from a video camera connected to a frame grabber card in a personal computer. The image is a grey scale 640 by 480 pixel image. The optics on the camera magnifies the abraded area so that the width of the imaged region is 7.3 mm (which is most of the 1 cm wide region that is abraded.)

The Adobe PhotoShop V7 with Reindeer Graphic's Image Processing Toolkit plug-ins for PhotoShop is used to process the image as described below.

First the image is converted to a grey scale image (if it is not already). A motion blur of 25 pixels in the direction of the scratches is performed to emphasize the scratches and de-emphasize noise and extraneous damage to the film. This blur does three things to clean up the image. First, damage to the film in other directions than the abrasion direction is washed out by averaging with the background. Second, individual white dots are removed by averaging with the background. Third, any small gaps in the scratches are filled in by averaging between the in line scratches.

In preparation for an automatic contrast adjustment of the pixel intensities in the image, four pixels near the upper left corner are selected. These pixels are filled in at an intensity of 200 (out of 255). This step assures that there is some mark in the image that is other than the dark background of the un-abraded material, in the event that there are no bright scratches in the image. This has the effect of limiting the automatic contrast adjustment. The automatic contrast adjustment used is called “histogram limits: max-min” which alters the contrast of the image so that the histogram fills the 0 to 255 levels available in an 8-bit grey scale image.

A custom filter is then applied to the image that takes a derivative in the horizontal direction and then adds back the original image to the derivative image. This has the effect of emphasizing the edges of vertical scratches.

A bi-level threshold is applied at the 128 grey level. Pixels at a level of 128 or higher are set to white (255) and pixels below a brightness of 128 are set to black (0). The image is then inverted making the black pixels white and the white pixels black. This is to accommodate the global measurement feature used in the final step, which is the application of the global measurement of the black area. The result is given in terms of the percent of black pixels in the image. This is the percent of the total area that is scratched by Method 1. The entire procedure takes a few seconds per image. Many abraded samples can be evaluated quickly and repeatably by this Method independent of a human operator required in conventional methods.

Method 5: Coating Method

A substrate film is coated with an uncured composition using a Yasui-Seiki Co. Ltd., Tokyo, Japan, microgravure coating apparatus as described in U.S. Pat. No. 4,791,881. The apparatus includes a doctor blade and a Yasui-Seiki Co. gravure roll #230 (230 lines/inch), 1.5 to 3.5 μm wet thickness range) having a roll diameter of 20 mm. Coating is carried out using a gravure roll revolution of 6.0 rpm and a transporting line speed of 0.5 m/min.

### Examples

### Table 1

Table 1 reports the following parameters and results for examples 1-9 and comparative examples A-E: “Thermal or UV Cure” (curing mechanism for the coating); Volume % nanosilica (100 times the quotient of the volume of dry nanosilica particles divided by the sum of the volumes of dry fluoroelastomer having cure sites, multiolefinic crosslinker, nanosilica particles, and initiator), Weight % nanosilica (100 times the quotient of the weight of dry nanosilica particles divided by the sum of the weights of dry fluoroelastomer having cure sites, multiolefinic crosslinker, nanosilica particles, and initiator), “Oxysilane” (identity of the oxysilane), “Oxysilane (molecules/nm²)” (molecules of oxysilane on average per square nanometer of nanosilica particle surface area of colloidal nanosilica used to form the nanosilica composite), “Rvis” (specular reflectance as determined by Method 2), “Haze” (haze as determined by Method 3), and “Scratched %” (quantification (percent area) of surface abrasion measured by Method 4).

### Example 1

A solid nanosilica mixture is formed by combining 2.65 g of APTMS at room temperature with 16.67 g of Nissan MEK-ST (dry density 2.32 g.cc). A hollow nanosilica mixture is formed by combining 0.96 g of APTMS at room temperature with 11.33 g of SKK Hollow Nanosilica. These mixtures are maintained separate at room temperature for about 24 hours before further use. Following this period, the solid nanosilica mixture contains APTMS and hydrolysis and condensation products of APTMS.

The median particle diameter d₅₀ of the solid nanosilica particles in the NISSAN MEK-ST, and the hollow nanosilica particles in the SKK Hollow Silica, is determined by the following procedure. A transmission electron micrograph negative of a large field of solid (or hollow) nanoparticles is scanned to produce a digital image. A SUN workstation using Khoros 2000 software is used for the image analysis of the particle size distribution. Approximately 150 solid nanosilica particles are analyzed, and median particle diameter d₅₀ of about 16 nanometers is measured. Approximately 150 hollow nanosilica particles are analyzed, and median particle diameter d₅₀ of about 41 nanometers is measured.

TABLE 1

| | | | | | | Oxysilane | Oxysilane | | | |
|---|---|---|---|---|---|---|---|---|---|---|
| | | | | | | per Solid | per Hollow | | | |
| | Thermal | Volume % | Weight % | Volume % | Weight % | Nanosilica | Nanosilica | | | |
| | or UV | Solid | Solid | Hollow | Hollow | (molecules/ | (molecules/ | R_{VIS} | | Scratched |
| EX. # | Cure | Nanosilica | Nanosilica | Nanosilica | Nanosilica | nm²) | nm²) | (%) | Haze | (%) |
| 1 | UV | 13.8 | 18.7 | 9.2 | 8.6 | 7.68 | 9.84 | 1.33 | 0.98 | 1.4 |
| 2 | UV | 9.1 | 12.7 | 9.1 | 8.7 | 7.68 | 9.84 | 1.25 | 0.46 | 1.9 |
| 3 | UV | 14.0 | 19.1 | 23.3 | 21.8 | 7.68 | 9.84 | 1.23 | 0.37 | 1.9 |
| 4 | UV | 13.3 | 18.7 | 8.9 | 8.6 | 7.68 | 9.84 | 1.44 | 0.97 | 3 |
| 5 | Thermal | 16.6 | 21.7 | 5.7 | 7.4 | 3.84 | 4.92 | 1.38 | 1.05 | 0.3 |
| A | Thermal | 16.2 | 21.2 | 0 (no hollow | 0 (no hollow | 3.84 | 0 (no hollow | 1.16 | 0.98 | 4.8 |
| | | | | nanosilica) | nanosilica) | | nanosilica) | | | |
| 6 | UV | 14.1 | 19.2 | 28.1 | 26.3 | 7.68 | 9.84 | 1.03 | 0.28 | 8 |
| 7 | UV | 11.5 | 15.9 | 30.2 | 28.5 | 7.68 | 9.84 | 0.99 | 0.22 | 6 |
| B | UV | 11.5 | 15.9 | 30.2 | 28.5 | 7.68 | 9.84 | 0.66 | 0.86 | 100 |
| C | UV | 13.8 | 18.7 | 9.2 | 8.6 | 7.68 | 9.84 | 1.06 | 0.67 | 26 |
| 8 | UV | 13.8 | 18.7 | 9.2 | 8.6 | 7.68 | 9.84 | 1.10 | 0.34 | 3.9 |
| 9 | UV | 17.3 | 21.6 | 0 | 0 | 12 | NA | 1.03 | 0.54 | 1.5 |
| D | UV | 17.3 | 21.2 | 0 | 0 | NA | NA | 1.18 | 0.28 | 98.4 |
| E | UV | 17.3 | 21.2 | 0 | 0 | NA | NA | 1.22 | 0.22 | 99.5 |

A mixture comprising fluoroelastomer is formed by combining 35.14 g of a 10 wt % solution of Viton® GF200S (dry density 1.8 g.cc) in propyl acetate, 0.39 g Sartomer SR533 (dry density 1.16 g/cc), 0.05 g Darocur ITX, 0.35 g Irgacure 651, and 0.18 g Genocure MBF in 40.55 g propyl acetate. The dry densities of Darocur ITX, Irgacure 651, and Genocure MBF is 1.15 g/cc.

To the mixture comprising fluoroelastomer is added 4.48 g of the solid nanosilica mixture and 2.61 g of the hollow nanosilica mixture.

The resultant uncured composition is then filtered through a 0.47 p Teflon® PTFE membrane filter and used for coating within two to five hours of preparation.

A 40.6 cm by 10.2 cm strip of acrylate hard-coated triacetyl cellulose film is coated with uncured composition by Method 5 (Coating Method).

The coated film is cut into 10.2 cm by 12.7 cm sections and cured by heating at 85° C. under a nitrogen atmosphere and irradiating with a VWR model B100P UV light source for 5 minutes. The lamp is placed two inches from the center of the coated film, and the lamp energy flux at this distance ranges from 2,000 to 8,400 J at 365 nm. The results are reported in Table 1.

The coated and cured film sections are abraded by Method 1 (Surface Abrasion). Rvis of the abraded film sections is measured by Method 2. Haze of the abraded film sections is measured by Method 3. Scratched % of the abraded film sections is measured by Method 4. The results are reported in Table 1.

### Example 2

The procedure of Example 1 is followed for this example with the following modifications. The mixture comprising fluoroelastomer is formed in 34.7 g propyl acetate. To the mixture comprising fluoroelastomer is added 2.80 g of the solid nanosilica mixture and 2.44 g of the hollow nanosilica mixture. The results are reported in Table 1.

### Example 3

The procedure of Example 1 is followed for this example with the following modifications. The mixture comprising fluoroelastomer is formed in 43.1 g propyl acetate. To the mixture comprising fluoroelastomer is added 5.60 g of the solid nanosilica mixture and 8.14 g of the hollow nanosilica mixture. The results are reported in Table 1.

### Example 4

The procedure of Example 1 is followed for this example with the following modifications. The mixture comprising fluoroelastomer additionally contains 0.5 g Sartomer SR454 (dry density 1.1 g/cc). The mixture comprising fluoroelastomer is formed in 40.5 g propyl acetate. To the mixture comprising fluoroelastomer is added 4.99 g of the solid nanosilica mixture and 2.90 g of the hollow nanosilica mixture. The results are reported in Table 1.

### Example 5

The procedure of Example 1 is followed for this example with the following modifications. The solid nanosilica mixture is formed by combining 1.32 g of APTMS at room temperature with 16.67 g of Nissan MEK-ST. The hollow nanosilica mixture is formed by combining 0.48 g of APTMS at room temperature with 11.33 g of SKK Hollow Nanosilica. The mixture comprising fluoroelastomer is formed by combining 45 g of a 10 wt % solution of Viton® GF200S in propyl acetate, 0.45 g benzoyl peroxide, and 0.45 g Sartomer SR454 in 60.18 g propyl acetate. To the mixture comprising fluoroelastomer is added 5.96 g of the solid nanosilica mixture and 2.68 g of the hollow nanosilica mixture. The coated film is cured by heating at 120° C. for 20 minutes in a nitrogen atmosphere. The results are reported in Table 1.

### Comparative Example A

The procedure of Example 5 is followed for this comparative example with the following modifications. The mixture comprising fluoroelastomer is formed in 50.3 g propyl acetate. To the mixture comprising fluoroelastomer is added 5.22 g of the solid nanosilica mixture. No hollow nanosilica mixture is added to the mixture comprising fluoroelastomer. The results are reported in Table 1.

### Example 6

The procedure of Example 1 is followed for this example with the following modifications.

A solid nanosilica mixture is formed by combining 2.65 g of APTMS at room temperature with 16.67 g of Nissan MEK-ST. A hollow nanosilica mixture is formed by combining 2.65 g APTMS at room temperature with 12.14 grams of the SKK hollow nanosilica. This mixture is maintained for about 24 hours before further use.

A mixture comprising fluoroelastomer is formed by combining 35.30 g of a 10 wt % solution of Viton® GF200S fluoroelastomer in MIBK (methyl isobutyl ketone), 0.39 g of Sartomer SR533 and 0.350 g of Irgacure 651, and 51.47 g of MIBK.

To the mixture comprising fluoroelastomer is added 5.80 g of the solid nanosilica mixture and 10.79 g of the hollow nanosilica mixture.

The coated film is cured using a UV exposure unit supplied by Fusion UV Systems/Gaithersburg Md. consisting of a LH-I6P1 UV source (200 w/cm) coupled to a DRS Conveyer/UV Processor (15 cm wide) with controlled nitrogen inerting capability over a measured range of 10 to 1,000 ppm oxygen.

Lamp power and conveyer speed are set to give a film cure using a measured energy density of 500-600 millijoules/cm² (UV-A irradiation) at about 0.7 to 1.0 m/min transport rate. An EIT UV Power Puck® radiometer is used to measure the UV total energy in the UV-A band width.

The “H” bulb used in the LH-I6P1 has the spectral output in the UV-B, UV-C and UV-V bands in addition to the UV-A mentioned above as shown in Table 2.

TABLE 2
“H” Bulb Spectral Performance at 2.5 m/min, 50% Power

| | | | | | line | Exp |
|---|---|---|---|---|---|---|
| | Range | Power | Energy | time | speed | Zone |
| Band | (nm) | (w/cm²) | (J/cm²) | (sec) | (m/min) | (cm) |
| UV-C | 250-260 | 0.107 | 0.079 | 0.7 | 2.5 | 3.1 |
| UV-B | 280-320 | 0.866 | 0.648 | 0.7 | 2.5 | 3.1 |
| UV-A | 320-390 | 0.891 | 0.667 | 0.7 | 2.5 | 3.1 |
| UV-V | 395-445 | 0.603 | 0.459 | 0.8 | 2.5 | 3.2 |

The oxygen level in the unit is controlled using a nitrogen purge to be at 350 ppm or less. The cured film is placed on a metal substrate preheated to 70° C. before placing it on the cure conveyer belt.

The coated and cured film sections are abraded by Method 1 (Surface Abrasion). Rvis of the abraded film sections is measured by Method 2. Haze of the abraded film sections is measured by Method 3. Scratched % of the abraded film sections is measured by Method 4. The results are reported in Table 1.

### Example 7

The procedure of Example 1 is followed for this example with the following modifications.

A solid nanosilica mixture is formed by combining 5.29 g of APTMS at room temperature with 33.33 g of Nissan MEK-ST. A hollow nanosilica mixture is formed by combining 3.83 g APTMS at room temperature with 48.54 grams of the SKK hollow nanosilica. These mixtures are maintained separate at room temperature for about 24 hours before further use.

A mixture comprising fluoroelastomer is formed by combining 35.88 g of a 9.85 wt % solution of Viton® GF200S fluoroelastomer in MIBK (methyl isobutyl ketone), 0.39 g of Sartomer SR533 and 0.350 g of Irgacure 651, 0.05 g Darocur® ITX, 0.18 g Genocure MBF and 50.29 g of MIBK.

To the mixture comprising the fluoroelastomer is added 4.96 g of the solid nanosilca mixture and 11.34 g of the hollow nanosilica mixture.

The coated film is cured by a procedure identical to that of Example 6. The coated and cured film sections are abraded by Method 1 (Surface Abrasion). The results are reported in Table 1.

### Comparative Example B

The procedure of Example 1 is followed for this example with the following modifications.

61.63 g of Nissan MEK-ST solid nanosilica was combined with 73.89 g of hexamethyldisilazane (HMDS, from Sigma Aldrich). This mixture is placed on a rotary evaporator and a vacuum is applied until approximately greater than 50 volume % of the solvent is removed. This results in a mixture with a syrup like consistency. This material is placed in a vacuum drying oven, with nitrogen flow, and heated to about 90° C. over the course of about 6 hours (4.5 hours at 90° C.). Analysis of the resultant HMDS-treated Nissan MEK-ST by infrared spectroscopy reveals that there is no band corresponding to reactive silanol groups observed at about 3737 cm⁻¹. The resultant HMDS-treated Nissan MEK-ST, which is a dry powder, is redispersed in MEK to create a colloid containing 30 wt % of the HMDS-treated Nissan MEK-ST nanosilica.

A solid nanosilica mixture is formed by combining 5.29 g of APTMS at room temperature with 7.77 g of the above-prepared colloid of the HMDS-treated Nissan MEK-ST nanosilica. A hollow nanosilica mixture is formed by combining 3.83 g APTMS at room temperature with 48.54 grams of the SKK hollow nanosilica. These mixtures are maintained separate at room temperature for about 24 hours before further use.

A mixture comprising fluoroelastomer is formed by combining 35.88 g of a 9.85 wt % solution of Viton® GF200S fluoroelastomer in MIBK (methyl isobutyl ketone), 0.39 g of Sartomer SR533 and 0.350 g of Irgacure 651, 0.05 g Darocur® ITX, 0.18 g Genocure MBF and 50.29 g of MIBK.

To the mixture comprising fluoroelastomer is added 4.96 g of the solid nanosilca mixture and 11.34 g of the hollow nanosilica mixture.

The coated film is cured by a procedure identical to that of Example 6. The coated and cured film sections are abraded by Method 1 (Surface Abrasion). The results are reported in Table 1.

### Comparative Example C

An APTMS sol is created by combining, in an inert atmosphere drybox, 10 g of APTMS with 12 grams of methyl ethyl ketone and 0.3 g of diisopropyaluminummethylacetoacetate. 3 g of water is added to this mixture. This mixture is subsequently refluxed for 4 hours at 60° C. to create the APTMS sol.

The procedure of Example 1 is followed for this example from this point on, with the following modifications.

A solid nanosilica mixture is formed by combining 6.70 g of the APTMS sol at room temperature with 5.0 g of Nissan MEK-ST. A hollow nanosilica mixture is formed by combining 2.42 g of the APTMS sol at room temperature with 2.50 grams of the SKK hollow nanosilica. These mixtures are maintained separate at room temperature for about 24 hours before further use.

A mixture comprising fluoroelastomer is formed by combining 35.14 g of a 10.06 wt % solution of Viton® GF200S fluoroelastomer in propyl acetate, 0.39 g of Sartomer SR533, 0.050 g of Darocur ITX, and 0.350 g of Irgacure 651, and 0.18 g Genocure MBF, 26.48 g of propyl acetate.

To the mixture comprising the fluoroelastomer is added 5.42 g of the solid nanosilca mixture and 2.92 g of the hollow nanosilica mixture. The amount of equivalent moles of APTMS (in the APTMS sol) added to this formulation is identical to that of example 1. The coated film is cured by a procedure identical to that of Example 6. The coated and cured film sections are abraded by Method 1 (Surface Abrasion). The results are reported in Table 1.

### Example 8

The procedure of Example 1 is followed for this example with the following modifications.

Solid nanosilica and hollow nanosilica are not precombined with APTMS.

A mixture comprising fluoroelastomer is formed by combining 35.14 g of a 10 wt % solution of Viton® GF200S in propyl acetate, 0.39 g Sartomer SR533, 0.05 g Darocur ITX, 0.35 g Irgacure 651, and 0.18 g Genocure MBF in 40.55 g propyl acetate.

To the mixture comprising fluoroelastomer is added 3.87 g of Nissan MEK-ST colloid and 2.36 g of SKK hollow nanosilicon oxide. To this mixture is then added 0.82 g of APTMS This mixture is maintained at room temperature for about 24 hours before further use.

The coated film is cured by a procedure identical to that of Example 6. The coated and cured film sections are abraded by Method 1 (Surface Abrasion). The results are reported in Table 1.

### Example 9

A solid nanosilica mixture is formed by combining 1.0 g of APTMS at room temperature with 6.0 g of Nissan MEK-ST. The mixture is maintained at 25° C. for about 24 hours before further use.

A mixture comprising fluoroelastomer is formed by combining 15.23 g of a 9.85 wt % solution of Viton® GF200S in propyl acetate, 0.15 g SR-533, and 0.09 g Irgacure® 907 in 13.5 g propyl acetate.

To the mixture comprising fluoroelastomer, is added 1.76 g of the solid nanosilica mixture.

The resultant uncured composition is then filtered through a 0.45μ glass micro-fiber membrane filter and used for coating within twenty-four hours of preparation.

A 40.6 cm by 10.2 cm strip of acrylate hard-coated triacetyl cellulose film is coated with uncured composition by Method 5 (Coating Method).

The coated film is cured by a procedure identical to that of Example 6. The coated and cured film sections are abraded by Method 1 (Surface Abrasion). The results are reported in Table 1.

### Comparative Example D

Vinyl modified/HMDS nanosilica particles are prepared using the procedure of published US patent application US 2006/0147177 A1 [0127] as follows.

A solution of 10 g 1-methoxy-2-propanol containing 0.57 g vinyltrimethoxy silane is prepared and added slowly to 15 g of gently stirring Nalco 2327 (40.9 wt % colloidal silica in water, ammonium stabilized) at ambient temperature. An additional 5.42 g (5 ml) of 1-methoxy-2-propanol is used to rinse the silane solution container into the silica mixture. The reaction mixture is heated to 90° C. for approximately 20 hours.

The reaction mixture is cooled to ambient temperature then gently evaporated to dryness by passing a nitrogen stream across the surface. The resultant white granular solids are combined with 50 ml tetrahydrofuran and 2.05 g hexamethyldisilazane (HMDS), then placed in an Ultrasonic bath for 10 hours to re-disperse and react. The resulting slightly cloudy dispersion is evaporated to dryness under vacuum on a rotary evaporator. The resulting solids are placed in 100° C. air-oven for about 20 hr. This yields 6.52 g of vinyl modified/HMDS nanosilica particles.

A dispersion of vinyl modified/HMDS nanosilica particles is prepared by combining 3.00 g of vinyl modified/HMDS nanosilica particles with 12.00 g of methylethyl ketone (MEK) then placing in an Ultrasonic bath for 12 hours to disperse. Not all of the particles disperse as there is a small amount of sediment in the dispersion. The dispersion is filtered through 0.45 micron glass micro-fiber filter to remove the sediment and yield a dispersion containing 20.4 w % vinyl modified/HMDS nanosilica particles in MEK.

A mixture comprising fluoroelastomer is formed by combining 23.23 g of a 10.76 wt % solution of Viton® GF200S in propyl acetate, 0.25 g SR-533, and 0.15 g Irgacure® 907 in 25.8 g propyl acetate.

To the mixture comprising fluoroelastomer, is added 3.83 g of the dispersion containing 20.4 w % vinyl modified/HMDS nanosilica particles in MEK.

The resultant uncured composition is then filtered through a 0.45 p glass microfiber membrane filter and used for coating within twenty-four hours of preparation.

A 40.6 cm by 10.2 cm strip of acrylate hard-coated triacetyl cellulose film is coated with uncured composition by Method 5 (Coating

Method).

The coated film is cured by a procedure identical to that of Example 6. The coated and cured film sections are abraded by Method 1 (Surface Abrasion). The results are reported in Table 1.

### Comparative Example E

A-174/HMDS nanosilica particles are prepared using the procedure of published US patent application US 2006/0147177 A1 [0128] as follows.

A solution of 10 g 1-methoxy-2-propanol containing 0.47 g 3-(trimethoxysilyl)propylmethacrylate (A174) is prepared and added slowly to 15 g of gently stirring Nalco 2327 (40.9 wt % colloidal silica in water, ammonium stabilized) at ambient temperature. An additional 5.42 g (5 ml) of 1-methoxy-2-propanol is used to rinse the silane solution container into the nanosilica mixture. The reaction mixture is heated to 90° C. for approximately 20 hours.

The reaction mixture is cooled to ambient temperature then gently evaporated to dryness by passing a nitrogen stream across the surface. The resultant white granular solids are combined with 50 ml tetrahydrofuran and 2.05 g hexamethyldisilazane (HMDS), then placed in an Ultrasonic bath for 10 hours to re-disperse and react. The resulting slightly cloudy dispersion is evaporated to dryness under vacuum on a rotary evaporator. The resulting solids are placed in 100° C. air-oven for about 20 hr. This yields 5.0 g of A-174/HMDS nanosilica particles.

A dispersion of A-174/HMDS nanosilica particles is prepared by combining 3.00 g of A-174/HMDS nanosilica particles with 12.00 g of methylethyl ketone (MEK) then placing in an Ultrasonic bath for 12 hours to disperse. Not all of the particles disperse as there is a small amount of sediment in the dispersion. The dispersion is filtered through 0.45 micron glass micro-fiber filter to remove the sediment and yield a dispersion containing 20.4 w % A-174/HMDS nanosilica particles in MEK.

A mixture comprising fluoroelastomer is formed by combining 23.23 g of a 10.76 wt % solution of Viton® GF200S in propyl acetate, 0.25 g SR-533, and 0.15 g Irgacure® 907 in 25.8 g propyl acetate.

To the mixture comprising fluoroelastomer, is added 3.83 g of the dispersion containing 20.4 w % A-174/HMDS nanosilica particles in MEK.

The resultant uncured composition is then filtered through a 0.45 p glass microfiber membrane filter and used for coating within twenty-four hours of preparation.

A 40.6 cm by 10.2 cm strip of acrylate hard-coated triacetyl cellulose film is coated with uncured composition by Method 5 (Coating Method).

The coated film is cured by a procedure identical to that of Example 6. The coated and cured film sections are abraded by Method 1 (Surface Abrasion). The results are reported in Table 1.

It is therefore, apparent that there has been provided in accordance with the present invention, a low refractive index composition, a liquid mixture for forming a low refractive index composition, an article comprising a substrate having an anti-reflective coating and a method for forming an anti-reflective coating on a substrate that fully satisfy the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A low refractive index composition comprising the reaction product of:
(i) a cross-linkable polymer;
(ii) a multiolefinic crosslinker;
(iii) a plurality of solid nanosilica particles;
(iv) a plurality of porous nanosilica particles;
(v) an oxysilane having at least one polymerizable functional group, and at least one of a hydrolysis and condensation product of said oxysilane; and
(vi) a free radical polymerization initiator; wherein the volume percent of said solid nanosilica particles is greater than 0 and less than or equal to about 20; the sum of the volume percent of said solid nanosilica particles and the volume percent of said porous nanosilica particles is less than or equal to about 45; and wherein volume percent is based on the sum of the dry volumes of said cross-linkable polymer, said multiolefinic crosslinker, said solid nanosilica particles and said porous nanosilica particles.

2. The low refractive index composition of claim 1, wherein said cross-linkable polymer comprises fluoroelastomer having at least about 65 percent by weight of fluorine and having at least one cure site selected from the group consisting of bromine, iodine and ethenyl.

3. The low refractive index composition of claim 2, wherein said fluoroelastomer comprises copolymerized units of vinylidene fluoride, hexafluoropropylene, tetrafluoroethylene, and iodine-containing cure site monomer.

4. The low refractive index composition of claim 1 wherein said plurality of solid nanoparticles have at least 20% but less than 100% of reactive silanols functionalized with an unreactive substituent.

5. The low refractive index composition of claim 1 wherein said plurality of solid nanosilica particles have a d₅₀ of about 30 nm or less.

6. The composition of claim 1, wherein said multiolefinic crosslinker comprises acrylic multiolefinic crosslinker- and allylic multiolefinic crosslinker.

7. The low refractive index composition of claim 1, wherein the ratio of volume percent solid nanosilica particles to volume percent porous nanosilica particles is from about 0.01:1 to about 4:1.

8. The low refractive index composition of claim 1, containing from about 0.3 to about 20 molecules of oxysilane per square nanometer of solid nanosilica particle surface area, and from about 0.4 to about 30 molecules of oxysilane per square nanometer of porous nanosilica particle surface area.

9. The low refractive index composition of claim 1, wherein said reaction product is formed in the substantial absence of compounds capable of catalyzing the hydrolysis of said oxysilane.

10. The composition of claim 1, wherein said oxysilane is represented by the formula X—Y—SiR¹R²R³, wherein:
X is a functional group selected from the group consisting of acryloyloxy, methacryloyloxy and epoxy;
Y is selected from the group consisting of alkylene radicals having 2 to 10 carbon atoms optionally including ether, ester and amide linkages therein, and arylene radicals having 6 to 20 carbon atoms optionally including ether, ester and amide linkages therein; and
R¹⁻³ are independently selected from the group consisting of alkoxy, aryloxy and halogen.

11. The composition of claim 1, wherein said free radical polymerization initiator comprises at least one photoinitiator with relatively strong absorption over a wavelength range of from about 245 nm to about 350 nm, and at least one photoinitiator with relatively strong absorption over a wavelength range of from about 350 nm to about 450 nm.

12. An optical film comprising a transparent substrate and having thereon a coating formed of the low refractive index composition according to claim 1.

13. The optical film of claim 12 having a scratched percent less than or equal to 10 as determined by Method 4 after abrasion by Method 1.

14. An anti-reflection film comprising a transparent substrate and an anti-reflection coating provided on the substrate, said anti-reflection coating comprising the low refractive index composition according to claim 1.

15. The antireflection film of claim 14 having a scratched percent less than or equal to 10 as determined by Method 4 after abrasion by Method 1.

16. A liquid mixture for forming a low refractive index coating, said mixture comprising: a solvent having dissolved therein:
(i) a cross-linkable polymer;
(ii) a multiolefinic crosslinker;
(iii) an oxysilane having at least one polymerizable functional group, and at least one of a hydrolysis and condensation product of said oxysilane
(iv) a free radical polymerization initiator;
and wherein said solvent has suspended therein:
(v) a plurality of solid nanosilica particles; and
(vi) a plurality of porous nanosilica particles;
wherein the volume percent of said solid nanosilica particles is greater than 0 and less than or equal to about 20; the sum of the volume percent of said solid nanosilica particles and the volume percent of said porous nanosilica particles is less than or equal to about 45; and wherein volume percent is based on the sum of the dry volumes of said cross-linkable polymer, said multiolefinic crosslinker, said solid nanosilica particles and said porous nanosilica particles.

17. An article comprising a substrate having an anti-reflective coating, wherein said coating comprises the reaction product of:
(i) a cross-linkable polymer;
(ii) a multiolefinic crosslinker;
(iii) a plurality of solid nanosilica particles;
(iv) a plurality of porous nanosilica particles; and
(v) an oxysilane having at least one polymerizable functional group, and at least one of a hydrolysis and condensation product of said oxysilane; and (vi) a free radical polymerization initiator; wherein the volume percent of said solid nanosilica particles is greater than 0 and less than or equal to about 20; the sum of the volume percent of said solid nanosilica particles and the volume percent of said porous nanosilica particles is less than or equal to about 45; and wherein volume percent is based on the sum of the dry volumes of said cross-linkable polymer, said multiolefinic crosslinker, said solid nanosilica particles and said porous nanosilica particles.

18. The article of claim 17 wherein said plurality of solid nanosilica particles are located within said antireflective coating substantially adjacent to said substrate.

19. The article of claim 17 having a specular reflectance of about 1.7 percent or less.

20. The article of claim 17, wherein the scratched percent of said anti-reflective coating is less than or equal to 10 as determined by Method 4 after abrasion by Method 1.

21. The article of claim 17, wherein the scratched percent of said anti-reflective coating is less than or equal to 5 as determined by Method 4 after abrasion by Method 1.

22. A method for forming an anti-reflective coating on a substrate comprising:
(i) preparing a liquid mixture comprising a solvent having dissolved therein:
(1) a cross-linkable polymer;
(2) a multiolefinic crosslinker;
(3) an oxysilane having at least one polymerizable functional group, and at least one of a hydrolysis and condensation product of said oxysilane; and
(4) a free radical polymerization initiator;
and wherein said solvent has suspended therein:
(5) a plurality of solid nanosilica particles;
(6) a plurality of porous nanosilica particles; wherein the volume percent of said solid nanosilica particles is greater than 0 and less than or equal to about 20; the sum of the volume percent of said solid nanosilica particles and the volume percent of said porous nanosilica particles is less than or equal to about 45; and wherein volume percent is based on the sum of the dry volumes of said cross-linkable polymer, said multiolefinic crosslinker, said solid nanosilica particles and said porous nanosilica particles;
(ii) applying a coating of said liquid mixture on a substrate to form a liquid mixture coating on said substrate;
(iii) removing solvent from said liquid mixture coating to form an uncured coating on said substrate; and
(iv) curing said uncured coating thereby forming an anti-reflective coating on said substrate.

23. The method of claim 22 wherein said plurality of solid nanosilica particles are located within said antireflective coating substantially adjacent to said substrate.

24. The method of claim 22, wherein said applying is carried out in a single pass by microgravure coating.
